(19) United States
(12) Patent Application Publication
(10) Pub. No.: US 2006/0284791 A1
(43) Pub. Date: Dec. 21, 2006

(54) Augmented reality system and method with mobile and interactive function for multiple users

(75) Inventors: Kuen-Meau Chen, Hsinchu City (TW); Lin-Lin Chen, Hsinchu City (TW); Ming-Jen Wang, Hsinchu City (TW); Whey-Fone Tsai, Hsinchu City (TW); Ching-Yu Yang, Hsinchu City (TW); Wen-Li Shi, Hsinchu City (TW)

Correspondence Address: BACON & THOMAS, PLLC, 625 SLATERS LANE, FOURTH FLOOR, ALEXANDRIA, VA, 22314, US

(73) Assignee: NATIONAL APPLIED RESEARCH LABORATORIES NATIONAL CENTER FOR HIGH-PERFORMANCE COMPUTING, Hsinchu City (TW)

(21) Appl. No.: 11/156,519

(22) Filed: Jun. 21, 2005

(51) Int. Cl. G09G 5/00

(52) U.S. Cl. 345/8

(57) ABSTRACT

An augmented reality system with mobile and interactive functions for multiple users includes two major portions: a computer system for handling augmented reality functions, and a user system for each user. The computer system for handling augmented reality functions has very powerful functionality for processing digital image data and transforming the digital image data into a three-dimensional virtual image for each user system. The user system mainly includes a Head-Mounted Display (HMD), a microphone and a PDA. A user can see the virtual image from the HMD and use the microphone or the PDA for communication with other users.

### BACKGROUND OF THE INVENTION

1. Field of the Invention

The present invention relates to an augmented reality system with mobile and interactive functions for multiple users that can, for example, be applied to virtual prototype evaluations for vehicles.

2. Description of the Related Art

Augmented reality is a new virtual reality technology that combines environmental images with computer virtual images.

An augmented reality kit (ARtoolKit) can provide users with one of the most natural of browsing methods; a virtual model will move or rotate with the viewing direction of the user, which provides a more vivid experience than browsing simply with a mouse or keyboard. However, the augmented reality kit requires huge computing capabilities, which are not offered by typical mobile computing devices, such as PDAs; any computer capable of providing this huge computing ability will inevitably have a large volume and little mobility.

Moreover, how to reach a discussion from different locations or even let one user can see other user's vision.

Therefore, it is desirable to provide an augmented reality system with mobile and interactive functions for multiple users to mitigate and/or obviate the aforementioned problems.

### SUMMARY OF THE INVENTION

A main objective of the present invention is to provide an augmented reality system with mobile and interactive functions for multiple users that can, for example, be applied to virtual prototype evaluations for vehicles. So multiple users can have real-time discussion at different locations, and even see other user's vision. These discussions can be performed by PDA so the users can also input comment for record.

In order to achieve the above-mention objective, the augmented reality system with mobile and interactive functions for multiple users includes two major portions: a computer system for handling augmented reality functions, and a user system for each user. The computer system for handling augmented reality functions has very powerful functionality for processing digital image data and transforming the digital image data into a three-dimensional virtual image for each user system.

The user system includes the head-mounted display, a camera and a microphone on the display, and a portable computer. The user utilizes the head-mounted display to watch the three-dimensional virtual image and the microphone or the portable computer to communicate with other user. The camera can obtain the viewing position of the user. When the user wants to see other user's vision, the augmented reality computer system can compute the other three-dimensional virtual image watched by other user by obtaining other user's position.

Other objects, advantages, and novel features of the invention will become more apparent from the following detailed description when taken in conjunction with the accompanying drawings.

### BRIEF DESCRIPTION OF THE DRAWINGS

FIG. 1 is a system structure drawing of the present invention which shows the performance environment in a single area.

FIG. 2 is a system structure drawing of the present invention which shows the performance environment in two different areas.

FIG. 3 is a structure drawing of a software program related to the present invention.

FIG. 4 is a flow chart for displaying virtual images according to the present invention.

FIG. 5 is a flow chart of showing a usage status for multiple users.

FIG. 6 is a drawing of an embodiment of a portable computer according to the present invention.

FIG. 7 is a schematic drawing of the present invention.

### DETAILED DESCRIPTION OF THE PREFERRED EMBODIMENT

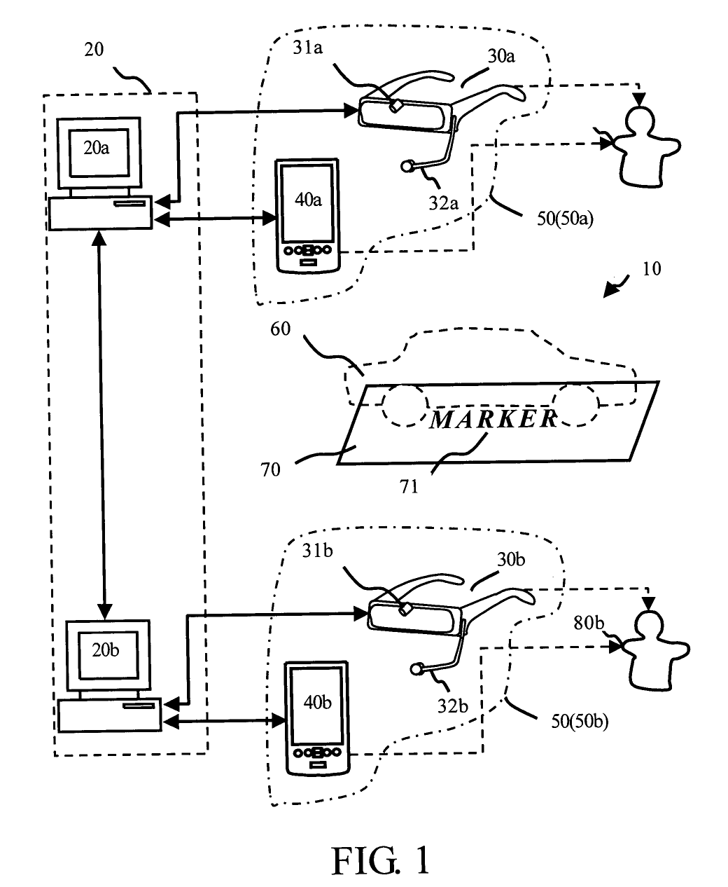

Please refer to FIG. 1. FIG. 1 is a system structure drawing of the present invention which is used for designing the appearance of vehicles.

The present invention provides an augmented reality system with mobile and interactive functions for multiple users 10, which includes two major portions: an augmented reality computer system 20, and multiple user systems 50 for each user. In this embodiment, there are two users 80a, 80b using the augmented reality computer system at the same time.

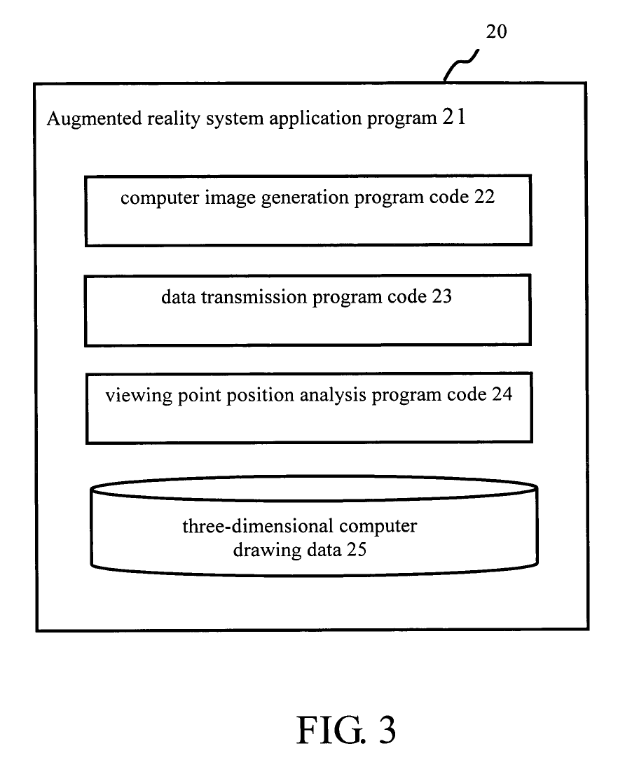

In this embodiment, the augmented reality computer system 20 comprises a first augmented reality computer subsystem 20a and a second augmented reality computer subsystem 20b, wherein each subsystem 20a, 20b are basically electrically connected together. With reference also to FIG. 3, each subsystem 20a, 20b utilizes one computer, and each subsystem 20a, 20b comprises an augmented reality system application program 21. In the present invention, the augmented reality system application program 21 comprises computer image generation program code 22, data transmission program code 23, viewing point position analysis program code 24 and three-dimensional computer drawing data 25. In this embodiment, the three-dimensional computer drawing data 25 is related to the vehicle appearance design drawing data.

The user system 50 comprises user systems 50a, 50b for each user 80a, 80b. The user system 50a comprises a head-mounted display 30a (which usually includes a speaker), a camera 3 la and a microphone 32a mounted on the head-mounted display 30a, and a portable computer 40a. Similarly, the user system 50b also comprises a head-mounted display 30b, a camera 31b, a microphone 32b and a portable computer 40b.

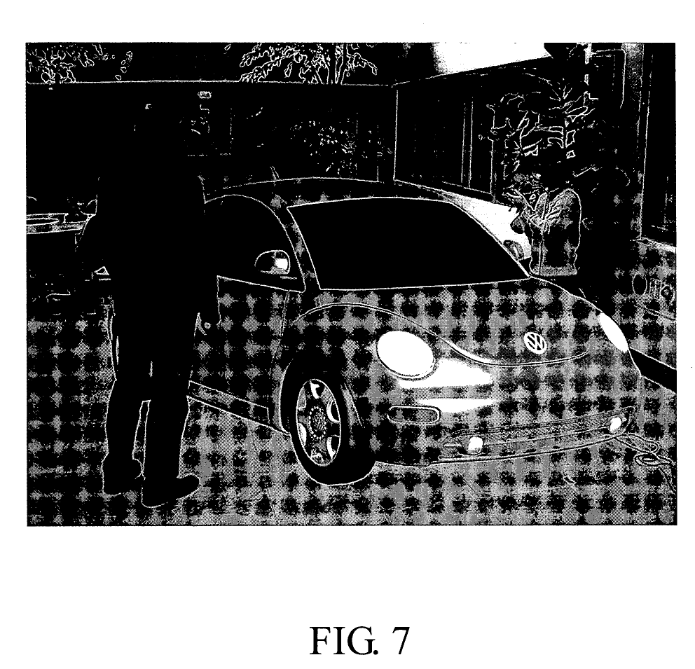

In this embodiment, each user 80a, 80b wears the head-mounted display 30a, 30b, and when the user 80a, 80b moves, his or her current position or the angle of his or her head changes, as does a virtual image 60 displayed a real image. There is a position reference object 70 in this embodiment; when the user 80a, 80b moves around the position reference object 70, the virtual image 60 displayed an image would be seen at the position of the position reference object 70, as shown in FIG. 7.

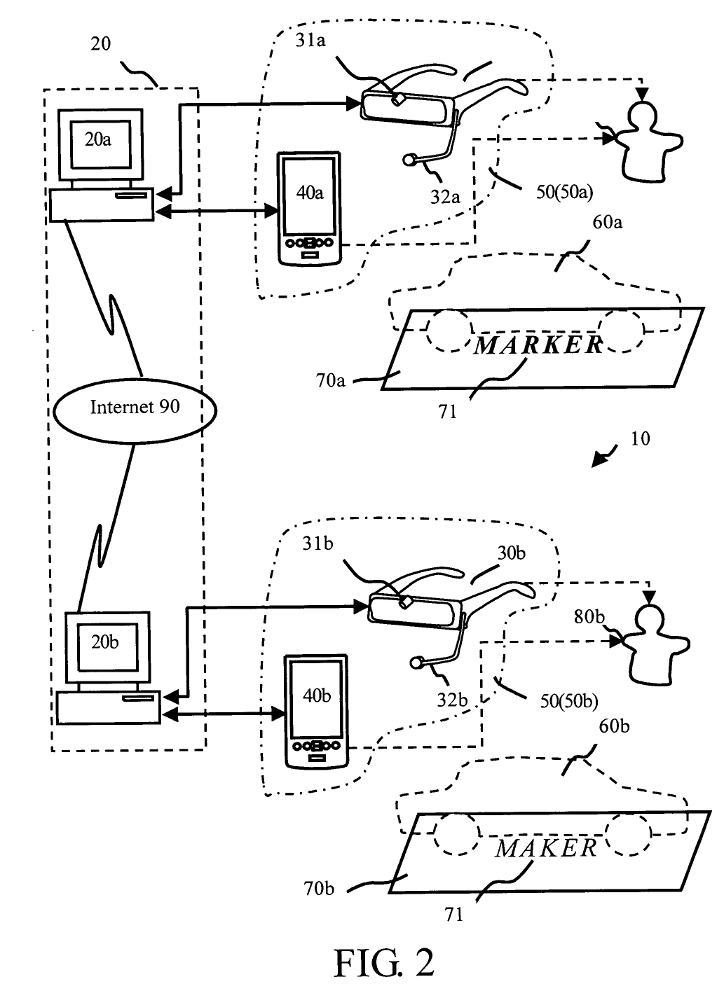

The embodiment of FIG. 1 is substantially a performance environment in a single area. Please refer to FIG. 2. FIG. 2 is a system structure drawing of the present invention which shows a performance environment in two different areas. The subsystems 20a, 20b are electrically connected together via the Internet 90 (or via an intranet for shorter distances). Since the users 80a, 80b are located at different positions, there are two different reference objects 70a, 70b, and the virtual images 60a, 60b are separately shown at the position of the reference objects 70a, 70b.

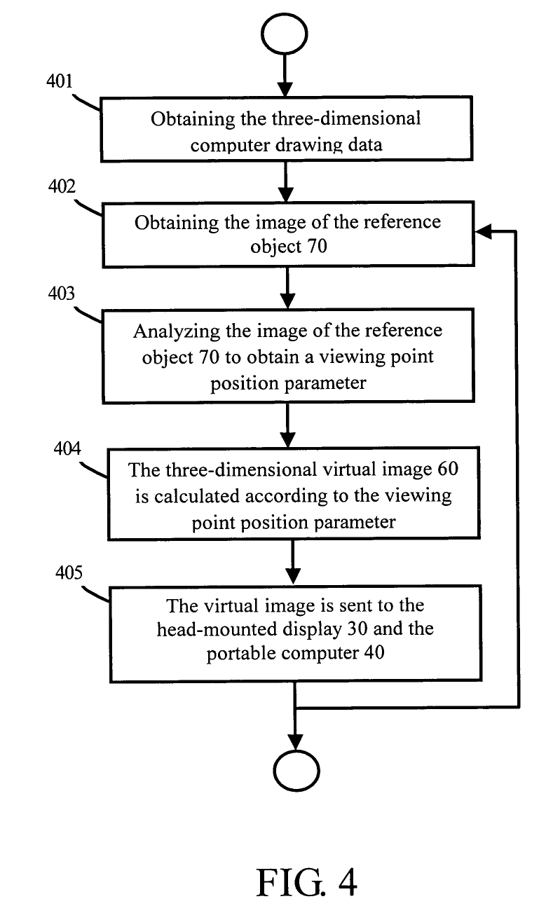

Please refer to FIG. 4. FIG. 4 is a flow chart for displaying virtual image according to the present invention. The following description is performed at the user 80a end:

Step 401:

The augmented reality computer subsystem 20a obtains the three-dimensional computer drawing data 25.

Step 402:

The image of the position reference object 70 is obtained; the camera 31a is placed on the head-mounted display 30a, so when the user 80a faces the position reference object 70, the camera 3 la can obtain an image of the position reference object 70 and send the image to the subsystem 20a.

Step 403:

The image of the position reference object 70 is analyzed to obtain a viewing point position parameter.

The viewing point position analyze program code 24 of the subsystem 20a analyzes the image of position reference object 70 to obtain the position of the viewing point of the user 80a. The position reference object 70 has a reference mark 71 (such as “MARKER”), and by analyzing the size, shape and direction of the reference mark, the position of the viewing point of the user 80a can be obtained, which is indicated by a viewing point position parameter (such as a coordinate or a vector, etc.). However, this is a well-known technology, and so requires no further description.

Step 404:

The three-dimensional virtual image 60 is calculated according to the viewing point position parameter; with the viewing point position parameter, the computer image generation program code 22 can transform the three-dimensional computer drawing data 25 into a three-dimensional virtual image 60. This process is a well known imaging procedure

Step 405:

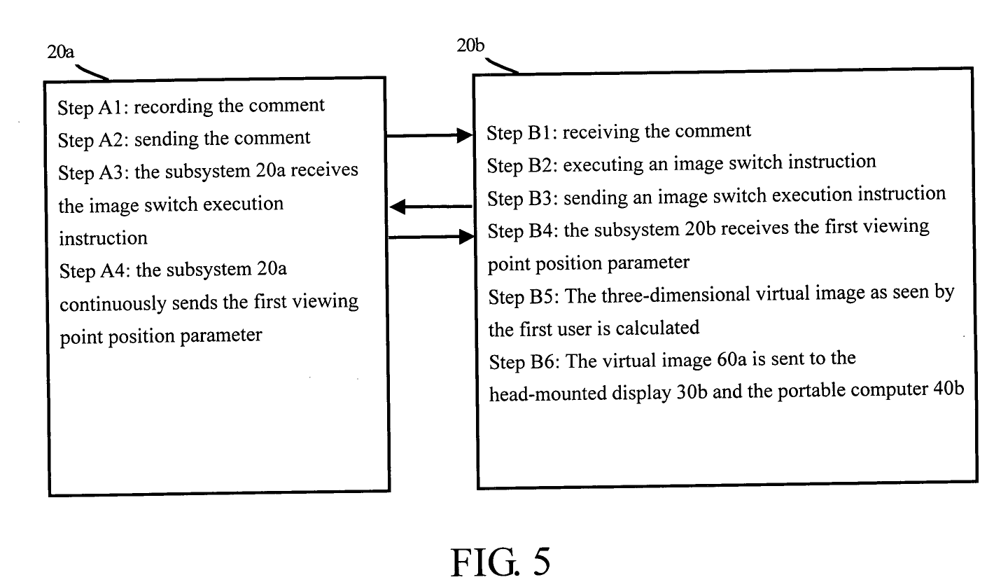

The virtual image 60 is sent to the head-mounted display 30 or the portable computer 40, so that the user 80a can see the virtual image 60. Please refer to FIG. 5. FIG. 5 is a flow chart of showing a usage status for multiple users. The following description considers when the user 80a wants to send his or her comments to the user 80b, or the user 80b wants to send his or her comments to the user 80a.

Step A1: Recording the Comment.

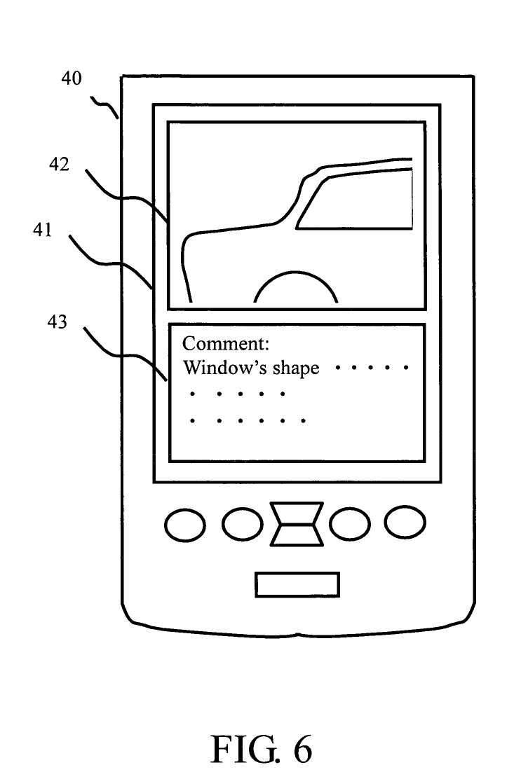

In the present invention, the user 80a can record his or her comments about the virtual image 60 in the portable computer 40a; for example, comments about the shape or color of the vehicle, or the inputting of instructions via the portable computer 40a to control the subsystem 20a to change the shape or color of the vehicle. Please refer to FIG. 6. The portable computer 40 is a PDA; a screen 41 of the portable computer 40 displays a virtual image window 42 and a comment window 43.

Step A2: Sending the Comment.

The user 80a sends a virtual image window 42 and a comment window 43 to the subsystem 20b via the subsystem 20a by controlling the portable computer 40a.

Step B 1: Receiving the Comment.

The subsystem 20b receives the virtual image window 42 and the comment window 43 sent from the subsystem 20a and sends the virtual image window 42 and the comment window 43 to the portable computer 40b.

Step B2: Executing an Image Switch Instruction.

If the user 80b wants to have a direct discussion with the user 80a, it is preferably to involve a discussion of the virtual image 60a as seen by the user 80a. The user 80b can use the portable computer 40b to execute the image switch instruction.

Step B3: Sending an Image Switch Execution Instruction.

The subsystem 20b sends an image switch execution instruction to the subsystem 20a.

Step A3: the Subsystem 20a Receives the Image Switch Execution Instruction.

Step A4: the subsystem 20a continuously sends the first viewing point position parameter, which is the viewing point of the user 80a.

Step B4: the subsystem 20b receives the first viewing point position parameter.

Step B5: The three-dimensional virtual image as seen by the first user is calculated.

Meanwhile, the subsystem 20b calculates the virtual image 60a according to the first viewing point position parameter.

Step B6: The virtual image 60a is sent to the head-mounted display 30b and the portable computer 40b.

The user 80b can thus see on the head-mounted display 30b the image seen by the user 80a. Since the first viewing point position parameter is a small sized piece of data, so it can be sent quickly.

Of course, while the user 80a changes his or her viewing position, step A4 will continuously be performed, as do steps B4-B6.

Furthermore, the users 80a, 80b can communicate via audio, particularly when the users 80a, 80b are at different positions (as shown in FIG. 2). For example, there are microphones 32a, 32b mounted in the head-mounted displays 30a, 30b, and the head-mounted displays 30a, 30b also have built-in speakers for real-time communications. Therefore, there may be no comments, and consequently no steps A1, A2, B1. Of course, the portable computers 40a, 40b may also have built-in microphones and speakers (not shown), in which case no microphones 32a, 32b and speakers need to be mounted in the head-mounted display 30a, 30b.

Data transmissions between the two subsystems 20a, 20b or between the subsystems 20a, 20b and the portable computer 40a, 40b can be performed by the data transmission program code 23.

Although the present invention has been explained in relation to its preferred embodiment, it is to be understood that many other possible modifications and variations can be made without departing from the spirit and scope of the invention as hereinafter claimed. For example. The augmented reality computer system 20 shown in FIG. 1 can be one super computer, and so there would be no need for other subsystems, or the three-dimensional computer drawing data 25 can be stored in another computer for sharing with the two computers.

What is claimed is:

1. An augmented reality system with mobile and interactive functions for multiple users comprising:
an augmented reality computer system for processing the following means:
a storage means for storing three-dimensional computer drawing data;
computer image generation means for transforming the three-dimensional computer drawing data into a three-dimensional virtual image;
data transmission means for receiving and outputting data;
a first user system and a second user system, wherein the first user system and the second user system are individually provided for a first user and a second user, and each user system includes a head-mounted display electrically connected to the augmented reality computer system; and
a user head position detection device for obtaining a position of each head-mounted display; by using the above-mentioned means to cause:
the augmented reality computer system utilizing the computer image computing means to calculate a first three-dimensional virtual image according to the position of the head-mounted display of the first user system and utilizing the data transmission means to output the first three-dimensional virtual image to the head-mounted display of the first user system;
utilizing the computer image computing means to calculate a second three-dimensional virtual image according to the head-mounted display of the second user system and the data transmission means to output the second three-dimensional virtual image to the head-mounted display of the second user system; and
the head-mounted display of the first user system also being able to display the second three-dimensional virtual image and the head-mounted display of the second user system also being able to display the first three-dimensional virtual image.

2. The system as claimed in claim 1, wherein the user head position detection device comprises:
a position reference object; and
two cameras, each camera separately mounted on each head-mounted display and electrically connected to the augmented reality computer system; each camera capable of obtaining an image of the position reference object;
wherein the augmented reality computer system further comprises a viewing point position analysis means for analyzing a position of each head-mounted display based upon a position reference object image to obtain a first viewing point position parameter and a second viewing point position parameter.

3. The system as claimed in claim 1, wherein the augmented reality computer system comprises a first augmented reality computer subsystem and a second augmented reality computer subsystem, wherein each augmented reality computer subsystem is electrically connected to a related user system, and each augmented reality computer subsystem comprises all means in the augmented reality computer system.

4. The system as claimed in claim 2, wherein the augmented reality computer system comprises a first augmented reality computer subsystem and a second augmented reality computer subsystem, wherein each augmented reality computer subsystem is electrically connected to a related user system, and each augmented reality computer subsystem comprises all means in the augmented reality computer system.

5. The system as claimed in claim 4, wherein before the head-mounted display of the first user system displays the second three-dimensional virtual image, the second augmented reality computer subsystem sends the second viewing point position parameter to the first augmented reality computer subsystem, and the first augmented reality computer subsystem utilizes the second viewing point position parameter to calculate the second three-dimensional virtual image by the computer image generation means.

6. The system as claimed in claim 1, wherein each user system further comprises a portable computer electrically connected to the augmented reality computer system, wherein the portable computer comprises a screen, and each user can be registered on the portable computer and sends the registration to another portable computer via the augmented reality computer system.

7. The system as claimed in claim 6, wherein each portable computer is capable of displaying the first three-dimensional virtual image and the second three-dimensional virtual image.

8. A method to provide multiple users with mobile and interactive functions on an augmented reality system, enabling a user to see a virtual image seen by another user, the method comprising:
in a first computer at a first user end:
step A1: calculating a first viewing point position parameter;
step B1: calculating a first three-dimensional virtual image according to the first viewing point position parameter;
step C1: sending the first three-dimensional virtual image to a first head-mounted display so a first user can see the first three-dimensional virtual image;
in a second computer at a second user end:
step A2: calculating a second viewing point position parameter;
step B2: calculating a second three-dimensional virtual image according to the second viewing point position parameter;
step C2: sending the second three-dimensional virtual image to a second head-mounted display so a second user can see the second three-dimensional virtual image;
step D2: receiving the first viewing point position parameter sent from the first computer;
step E2: calculating a first three-dimensional virtual image according to the first viewing point position parameter; and
step F2: sending the first three-dimensional virtual image to the second head-mounted display so the second user can see the first three-dimensional virtual image.

9. The method as claimed in claim 8, wherein the second computer performs step D2 after receiving a switch image command.

10. The method as claimed in claim 8, wherein:
the first user comprises a first portable computer electrically connected to the first computer subsystem so the first portable computer can display the first three-dimensional virtual image, the first user capable of registering with the first portable computer;
the second user comprises a second portable computer electrically connected to the second computer subsystem so the second portable computer can display the second three-dimensional virtual image, the second user capable of registering with the second portable computer; and
in the second computer at the second user end, the method further comprises:
step G2: receiving the registration of the first portable computer and sending the registration to the second portable computer.
